(19) United States
(12) Patent Application Publication
(10) Pub. No.: US 2014/0324522 A1
(43) Pub. Date: Oct. 30, 2014

(54) Detecting Fraud In Internet-Based Lead Generation Utilizing Neural Networks

(71) Applicant: FAIR ISAAC CORPORATION, Roseville, MN (US)

(72) Inventors: Jeffrey K. Wilkins, Boulder, CO (US); Ian J. Wilkins, Boulder, CA (US)

(73) Assignee: FAIR ISAAC CORPORATION, Roseville, MN (US)

(21) Appl. No.: 13/872,795

(22) Filed: Apr. 29, 2013

(51) Int. Cl. G06Q 30/02

(52) U.S. Cl. CPC G06Q 30/0201
USPC 705/7.29

(57) ABSTRACT

Artificial neural network models trained using historical lead data are used to identify leads that are likely to be fraudulent or inaccurate and to additionally identify lead sources that provide leads likely to be fraudulent or inaccurate. Related apparatus, systems, techniques and articles are also described.

### TECHNICAL FIELD

The subject matter described herein relates to the use of advanced predictive models including neural networks to characterize Internet-based leads as potentially fraudulent and/or inaccurate.

### BACKGROUND

Online marketing has become an integral part of the sales and marketing efforts of business. According to eMarketer; US online ad spending will grow from $37.5 billion in 2012 to over $55 billion in 2015. Online advertising is typically classified based on its objective into either branding, or direct response. Direct response advertising is forecast to grow from $22 billion in 2012 (58.7% of total ad spend) to $27.5 billion in 2015 (50.0%).

In some cases the goal of direct response advertising is not e-commerce; but rather identifying consumers with an interest in, or affinity for, a product. This process is called lead generation. In some cases, basic leads are captured that include name of the entity requesting more information, contact information, the source URL, IP address, and the time/date stamp. In other cases, the answers to additional advertiser-supplied questions are collected. According to eMarketer, more than $1.7 billion will be spent in the US on online lead generation in 2012. Lead generation programs are usually priced on a cost-per-lead basis.

Historically, lead generation has been plagued by poor data quality and fraud. Industry efforts to fight fraud started with simple data cleansing and evolved to data verification. In recent years, the sophistication of fraud has increased necessitating the need for new approaches to detection. Industry estimates of the incidence of fraud range from 20-70+%, based on the market segment and data elements collected.

### SUMMARY

In one aspect, data characterizing one or more leads is received. Thereafter, it is determined, for each of the one or more leads, whether the lead is likely to be fraudulent and/or inaccurate using at least one artificial neural network model having at least one classification feature empirically derived using a plurality of historical leads with known outcomes. Data can subsequently be provided (e.g., stored, loaded, displayed, transmitted, etc.) identifying those leads that are determined to be fraudulent and/or inaccurate.

The artificial neural network model can be used to generate a score for each lead. For such arrangements, scores above a pre-determined threshold are determined to be likely fraudulent or inaccurate.

The leads can be web-generated leads including, without limitation, user-generated subscriptions, account registrations on a website, and user-generated requests for products and/or services.

The at least one empirically derived classification feature can be based on a variety of attributes including, without limitation, a time of day calculation threshold, a number of prior moves as percentage of total lead volume, IP hostname binding percentages, IP address geolocation percentages, e-mail domain distribution for leads coming from each lead source, a comparison of a captured IP address with an IP address associated with a lead submission, a percentage of duplicate IP addresses within a plurality of leads, a number of IP addresses associated with a single consumer, a number of consumers associated with a single IP address, a number of e-mail addresses associated with a single consumer, a number of consumers associated with a single e-mail address, a number of individuals having different last names associated with a single physical place of residence, a frequency of use for a particular street address, a number of consumers associated with a single telephone number, a geographic distribution of a plurality of leads, and/or a percentage of names having a common ethnic origin as compared to population statistics characterizing ethnic origins of individuals within a geographic territory.

In an interrelated aspect, data characterizing one or more lead sources is received. Thereafter, it is determined, for each of the one or more lead sources, whether the lead source provides leads likely to be fraudulent and/or inaccurate using at least one artificial neural network model having at least one classification feature empirically derived using a plurality of historical leads with known outcomes. Data can then be provided that identifies those lead sources that are determined to provide fraudulent and/or inaccurate leads.

Computer program products are also described that comprise non-transitory computer readable media storing instructions, which when executed one or more data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The subject matter described herein provides many advantages. For example, the current subject matter enables leads and/or lead sources that are likely to be fraudulent to be earlier identified so that appropriate remedial measures can be undertaken.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating the poor predictive power of verification techniques commonly used for lead source fraud detection;

FIG. 2 is a diagram illustrating how time of day can be used to derive one or more classification features;

FIG. 3 is a diagram illustrating how a number (or fraction) and timing of moves can be used to derive one or more classification features;

FIG. 4 is a diagram illustrating how IP address/hostname binding percentages by source can be used to derive one or more classification features;

FIG. 5 is a diagram illustrating how an IP address implied state vs. a self-reported state can be used to derive one or more classification features;

FIG. 6 is a diagram illustrating training performance for varying numbers of hidden neurons;

FIG. 7 is a first diagram illustrating the assessment of classifier performance using a confusion matrix, along three dimensions of accuracy, sensitivity and specificity;

FIG. 8 is a second diagram illustrating performance of traditional and artificial neural network lead source classifiers with a confusion matrix;

FIG. 9 is a third diagram illustrating performance of traditional and artificial neural network lead source classifiers along three dimensions of accuracy, sensitivity and specificity;

FIG. 10 is a process flow diagram illustrating a technique for fraudulent lead detection;

FIG. 11 is a process flow diagram illustrating a technique for fraudulent lead source detection;

FIG. 12 is a table identifying a dataset with abnormal e-mail domain name distributions from highlighted lead sources;

FIG. 13 illustrates a dataset with numerous leads using the same mailing address;

FIG. 14 illustrates a dataset with numerous leads using the same phone number; and

FIG. 15 illustrates a data set illustrating a large concentration of leads having individuals with surnames and names having a common, yet abnormal, ethnic origin.

### DETAILED DESCRIPTION

The current subject matter is based, in part, on research that utilized previously generated leads. In particular, 1,910,234 US leads were gathered from 45 lead sources/affiliates. Leads were collected from several large lead buyers in the consumer packaged goods (CPG), higher education and financial services industries. The research analyzed lead data elements commonly collected, including both contact information and lead metadata:

| Contact Information | Lead Metadata |
|---|---|
| Name | IP Address |
| Postal Address | Time/Date Stamp |
| E-mail Address | Source ID/Sub-source ID |
| Telephone Number | |

In addition, lead buyers were asked to label each source as good or fraudulent. Typically, lead buyers assess quality by affirmative measures such as response rate (e.g. opens/clicks on e-mail campaigns, sales conversions) or by negative indicators such as complaint rates on subsequent campaigns/contacts.

Feature Extraction.

Based on preliminary data, a series of features were derived from the data and evaluated for use in source classification. Candidate features evaluated included:

Name/Postal Address.
Postal Address Quality. Delivery point verification was performed to determine if the postal address was validated by the United States Postal Service.
Prior Move Percentage. Postal addresses were matched against the National Change of Address (NCOA) database. Over 43 million Americans move every year. Leads freshly captured off the Internet should exhibit a 0% NCOA rate.
Consumer Verification (%)—Lead name and addresses were matched against a US consumer marketing database. A “low” match percentage would be indicative of a poor lead source. A high match percentage might be indicative of a high quality lead source, or sophisticated fraud.

E-mail Address.
Verification Percentage. The quality of e-mail addresses was measured through direct e-mail server verification. With an estimated 20-30% churn per year, lead sources supplying recycled lead data should have a lower e-mail verification percentage than legitimate sources.
Domain Distribution. A histogram of e-mail domain names was counted, to determine if a characteristic pattern existed for good and fraudulent sources.

Telephone Number.

The fraction of valid area code and prefix combinations was computed.

IP Address
IP-Host Name Binding Percentage. IP addresses assigned to computers that are to be used by humans are commonly given a hostname. This commonly includes the device a consumer uses to access the Internet. A low binding percentage may indicate data center bots are completing the lead forms or the presence of other fraud.
Routable Status Percentage. Every device on the Internet has an IP Address. The current standard, IPv4, is comprised of 32 bit addresses for a theoretical maximum of just under 4.3 billion addresses. Approximately 3 billion addresses are currently in use. These addresses are “assigned” or “allocated” and routable. Bogus, reserved, unallocated, and unknown, are IP Status types that are highly suspect. Valid leads should not have them.
IP Geolocation Percentage. In many instances, IP addresses correspond to physical locations. Although there are legitimate cases (e.g. travel, proxy servers) that may not match, comparing the correspondence between the state of the postal address and the IP-inferred state can detect fraudulent IP assignment.
IP Duplication Percentage. The percentage of inter-source duplication and intra-source duplication can flag fraud. The variance in number of source samples precluded use.

Time/Date Stamp.
Circadian Rhythm. Internet activity varies during the course of the day and night. It was discovered that good lead sources exhibited a relatively constant level of activity between 7 AM and 9 PM Mountain Time. Two features were created: the hour by which 25% and 75% of the day's lead volume was received.

The current subject matter can employ a wide variety of models in order to identify lead fraud. One example, is logistic regression which is a statistical technique used for predicting the outcome of a categorical dependent variable (a dependent variable that can take on a limited number of categories) based on one or more predictor variables. In the case of fraud detection, a binomial logistic regression with the dependent variable either “Good” (“0”) or “Fraud” (“1”).

One form of the equation for a logistic regression model is:

$$π ( x ) = \frac{{e}^{A + {B}_{1} {X}_{1} + {B}_{2} {X}_{2} + … + BnXn}}{1 + {e}^{A + {B}_{1} {X}_{1} + {B}_{2} {X}_{2} + … + BnXn}}$$

Where π(x) is the logistic function, {X₁, X₂, . . . Xₙ} is the feature vector to be classified, and A and {B₁, B₂, . . . Bₙ} are model coefficients.

A simple threshold rule can be employed for binomial classification:

$$C ( x ) = \{ \begin{matrix}0 , & π ( x ) < 0.5 \\ 1 , & π ( x ) \geq 0.5\end{matrix}$$

A logistic regression model was built using the R programming language and development environment (R Version 2.15.2, The R Foundation for Statistical Computing). Independent variables included in the model were traditional data cleansing and verification attributes currently used to assess lead fraud:

1) Postal Address Quality, as measured by the delivery point validation database (DPV)
2) E-mail verification, as measured by ISP/ESP direct confirmation
3) Telephone area code+prefix validation
4) Consumer verification, using the name and postal address, at either an individual- or household-level.

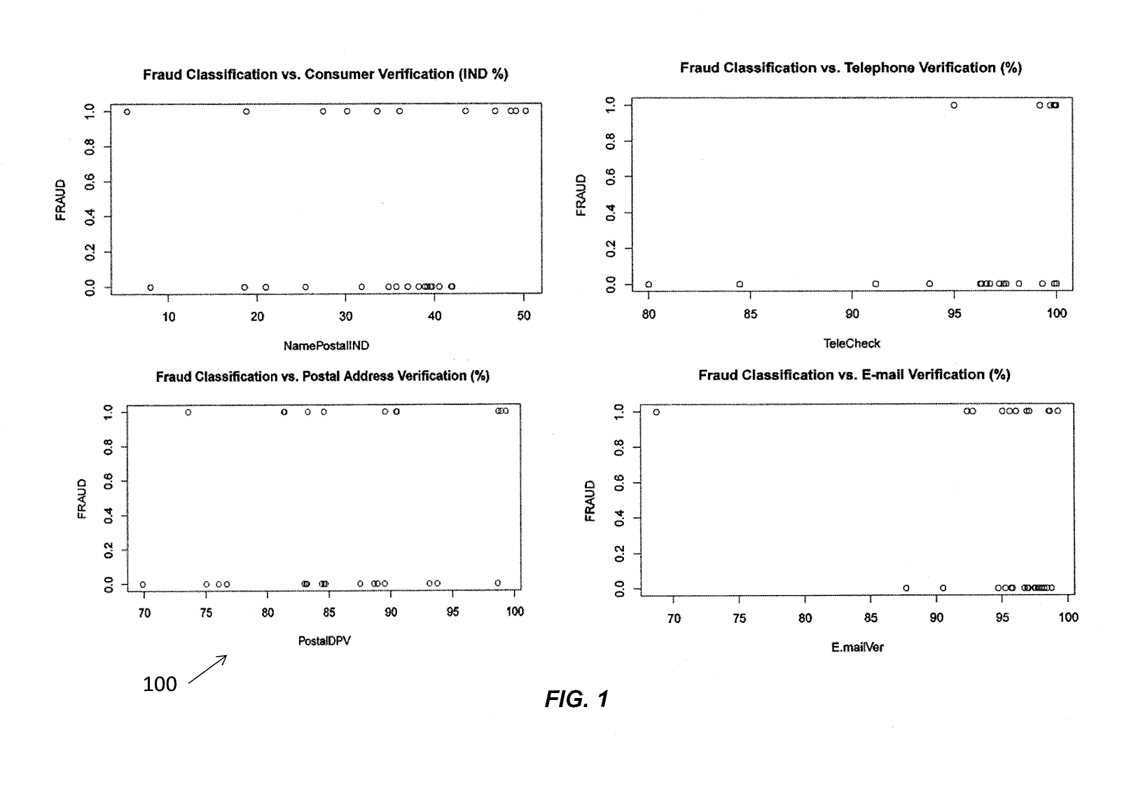

Based upon preliminary data analysis, the aforementioned variables did not exhibit predictive power (see the charts included in the diagram 100 of FIG. 1). A review of the correlation matrix indicated that co-linearity of the variables was not an issue, with most pairwise correlation coefficients between +/−0.3 and none above 0.52. As a result, all independent variables were used in the logistic regression model. The Wald statistic was used to assess the significance of the model coefficients. None were significant at even the 0.05 level.

Artificial Neural Network with Enhanced Features.

The current subject matter can utilize artificial neural network (ANN) theory. An ANN comprises a series of nodes, “the neurons”, with interconnected weighted edges, “the synapses”, converging on an output. The mathematical equation determining the activation function, “action potential”, of each node is a nonlinear weighted sum of its inputs which is called the activation function and is typically a sigmoid function such as the hyperbolic tangent or logistic functions. The node signals to the next nodes in the network in a layered, feed-forward topology until an output is reached. In particular, the current subject matter can be implemented using a feedforward neural network comprised of an input layer, hidden neurons, and an output neuron. The neural network can be trained using backpropagation with a small decay term with neurons utilizing a sigmoid transfer function.

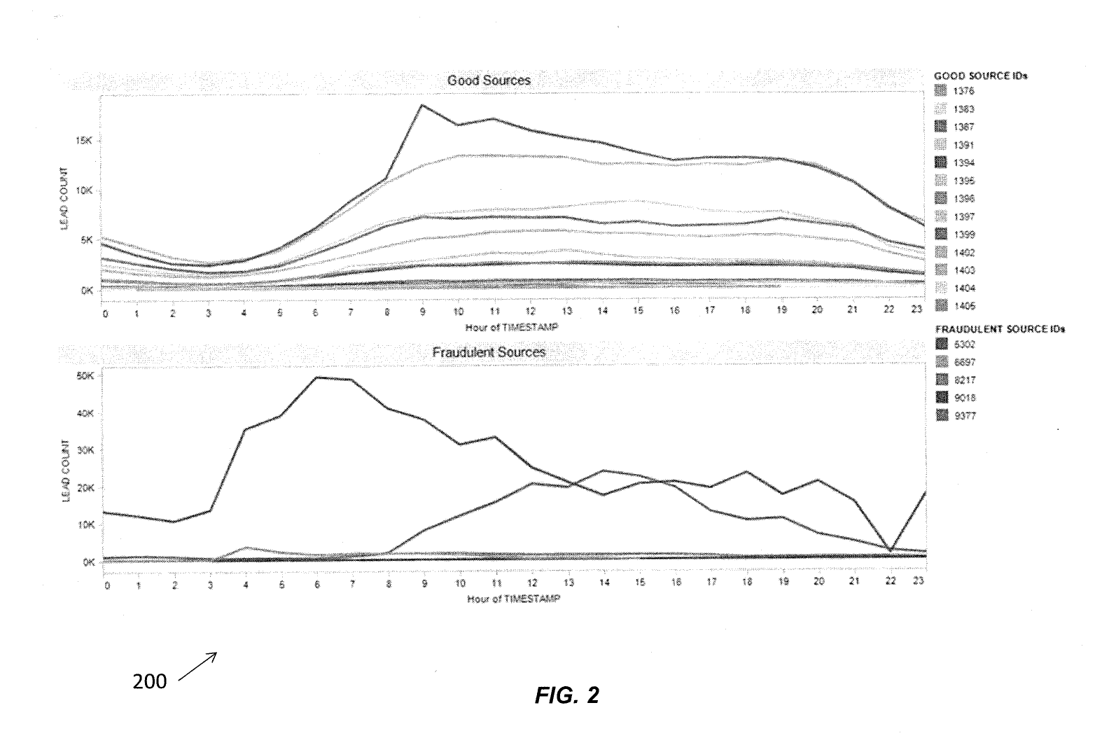

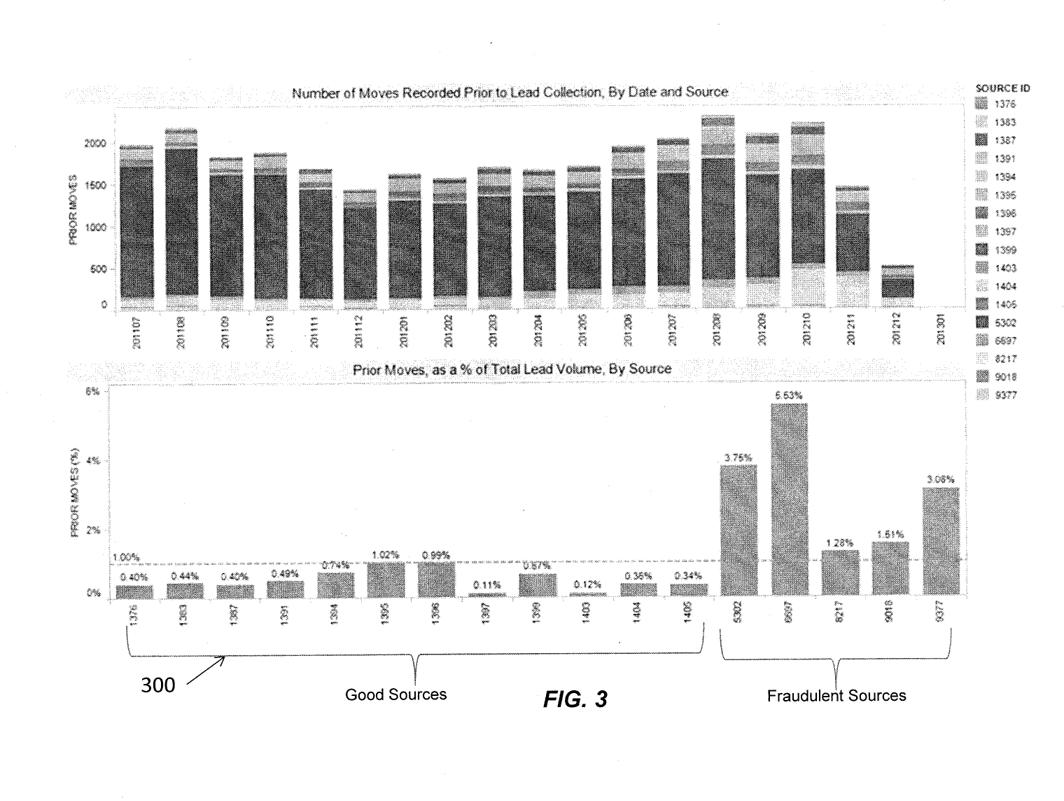

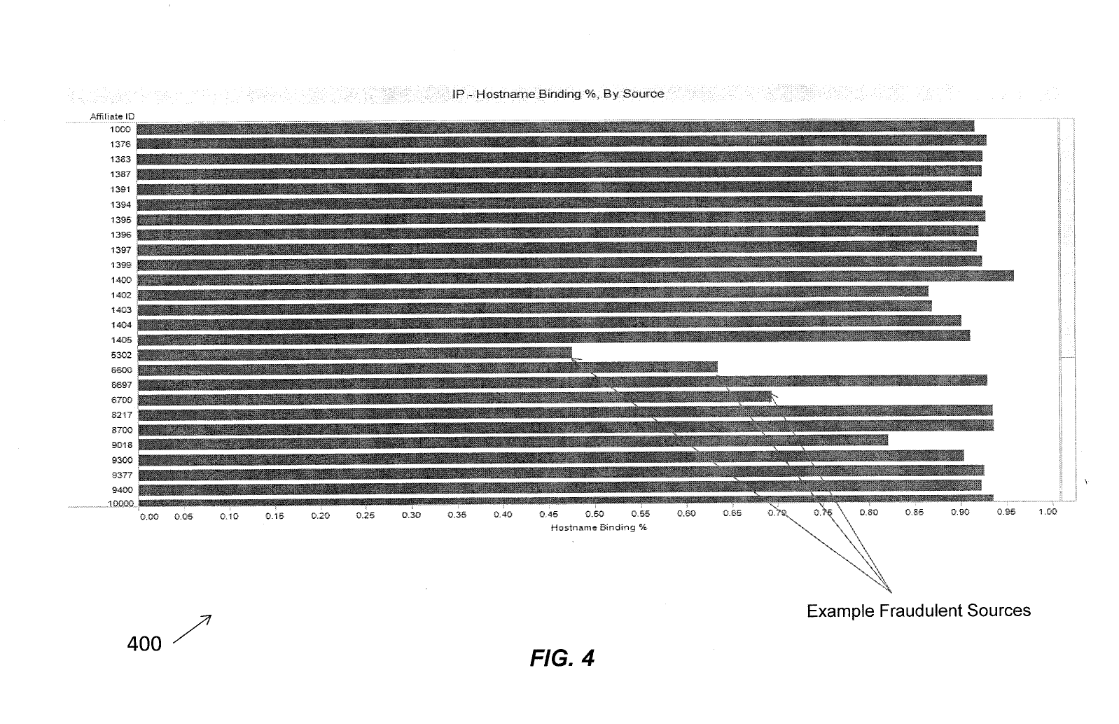

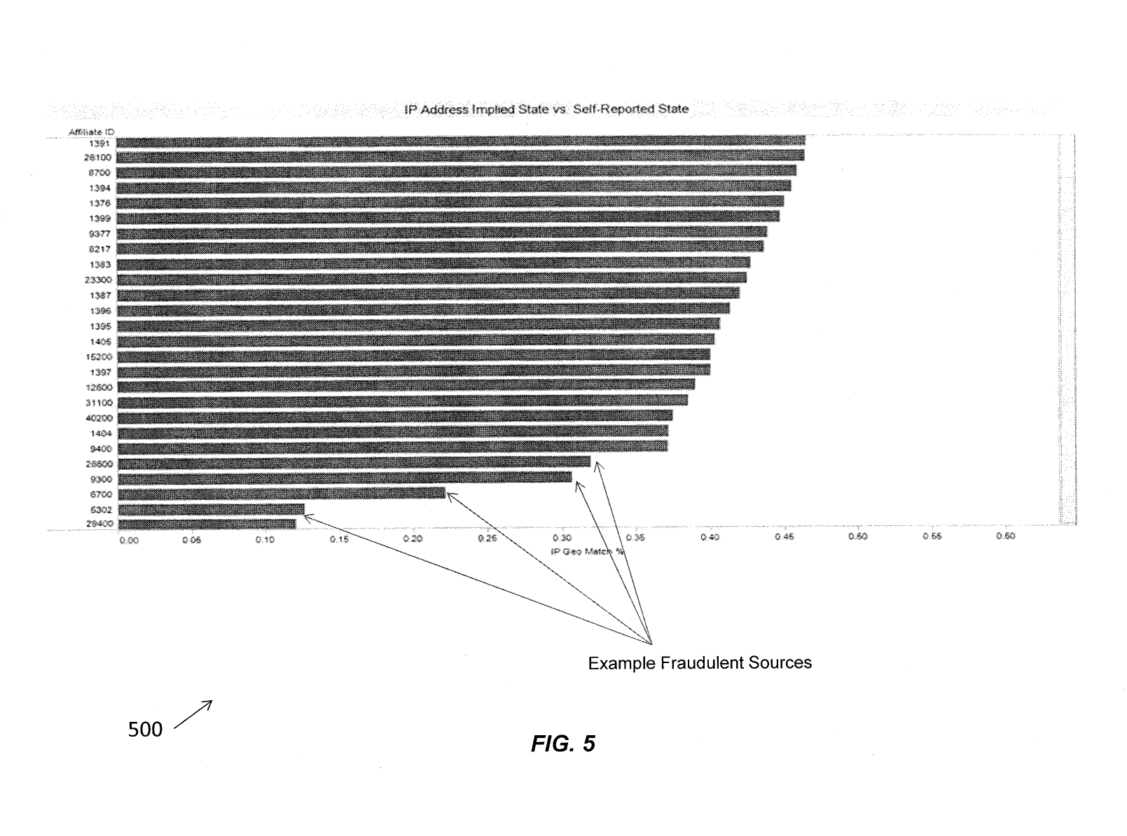

The number of inputs for the ANN can be determined by selecting classification features (in this example five classification features). The diagram 200 of FIG. 2 shows how time of day can be used to create two classification features (a) the last hour in which the cumulative volume was less than 25% of the total and b) the last hour in which the cumulative volume was less than 75% of the total. Another feature can be based on prior moves as a percentage of total lead volume by source (as illustrated in the diagram 300 of FIG. 3). In addition, IP hostname binding percentages can be used as a feature (see diagram 400 of FIG. 4) as well as IP geolocation percentages (as illustrated in diagram 500 of FIG. 5).

Various techniques can be used to govern the selection of the number of hidden neurons. A general rule of thumb is that the optimal size of the hidden layer is usually between the size of the input layer and the output layer. With the above example, given that five features were used in the input layer, and there is a single neuron in the output layer, the number of hidden neurons would be 2, 3 or 4. More hidden neurons generally results in better performance on the training data set. However, to promote good generalization performance, and avoid over-fitting, it can be generally desirable to use a neural network with the minimum number of hidden units compatible with good training performance.

Neural networks with varying number of hidden neurons can be created during design-time. For example, for a five features identified above, neural networks with 2, 3, and 4 hidden units were created. Each network can be trained, for example, 10 times, using randomly selected initial weights. The order of training samples can be randomly selected in each iteration.

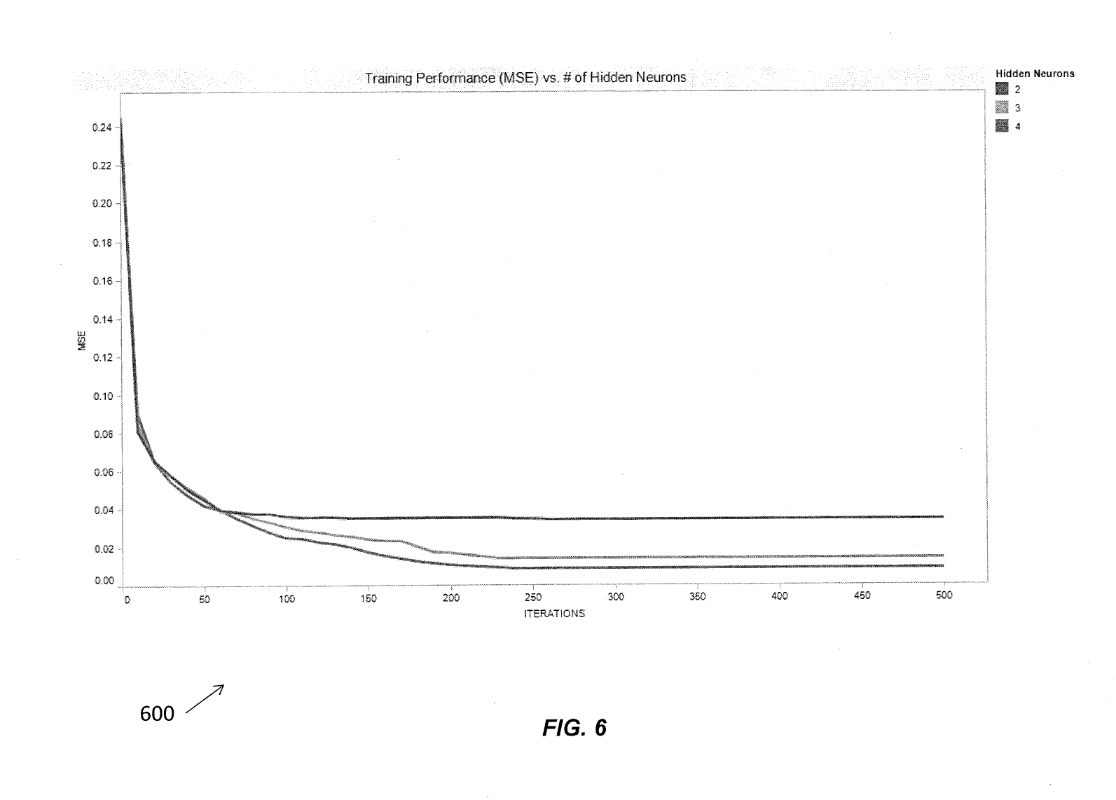

Training can be conducted in batches, for example batches of 10 iterations, at the end of which the sum of squared errors (SSE) for the training set can be computed. Training continued until either the SSE converged (change less than 0.000001) or 500 iterations was reached. An average training curve can be computed for each of the cases, 2, 3, and 4 hidden neurons (see diagram 600 of FIG. 6). Three neurons was selected as representing a good trade-off between training performance and generalizability.

Various numbers of output neurons can be used including a single output neuron. With the current example, for the test data, a threshold function of 0.5 was used to generate a classification decision. More specifically, when the output neuron's sigmoid function output is greater than 0.5, the classification is “1” indicating fraud.

Results.

With the current example, of the 45 available lead sources, 30 had complete data needed for construction and evaluation of both the traditional and artificial neural network (ANN) classifiers. 50% of lead sources were randomly selected and use to train each classification feature. The remaining 50% was used to test classification performance on previously unseen data.

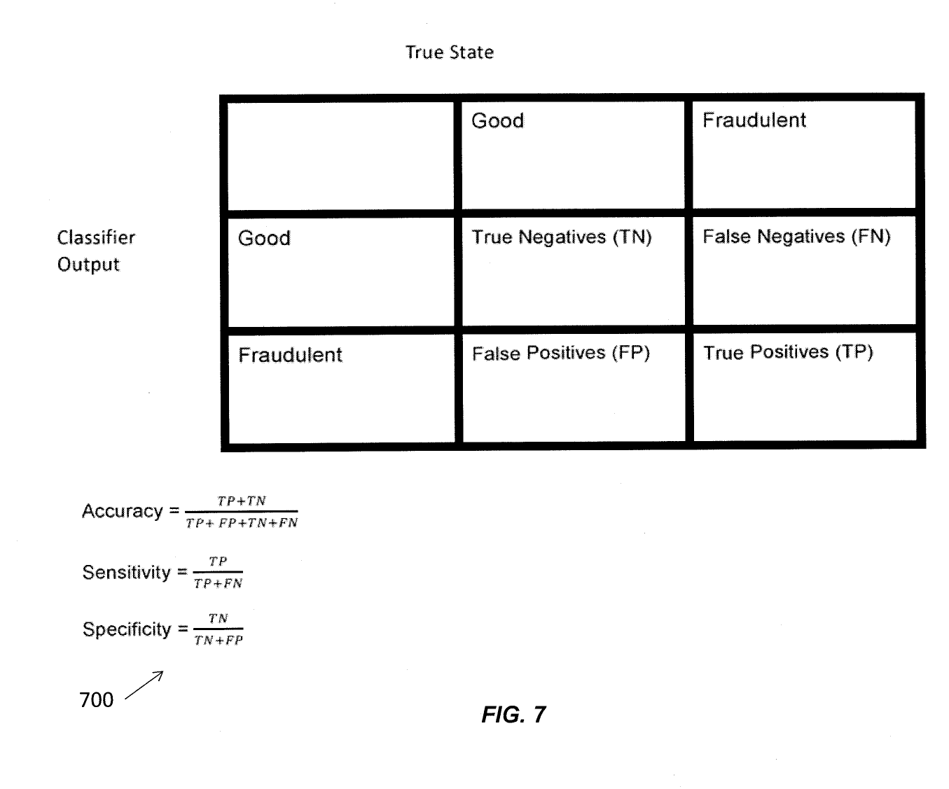

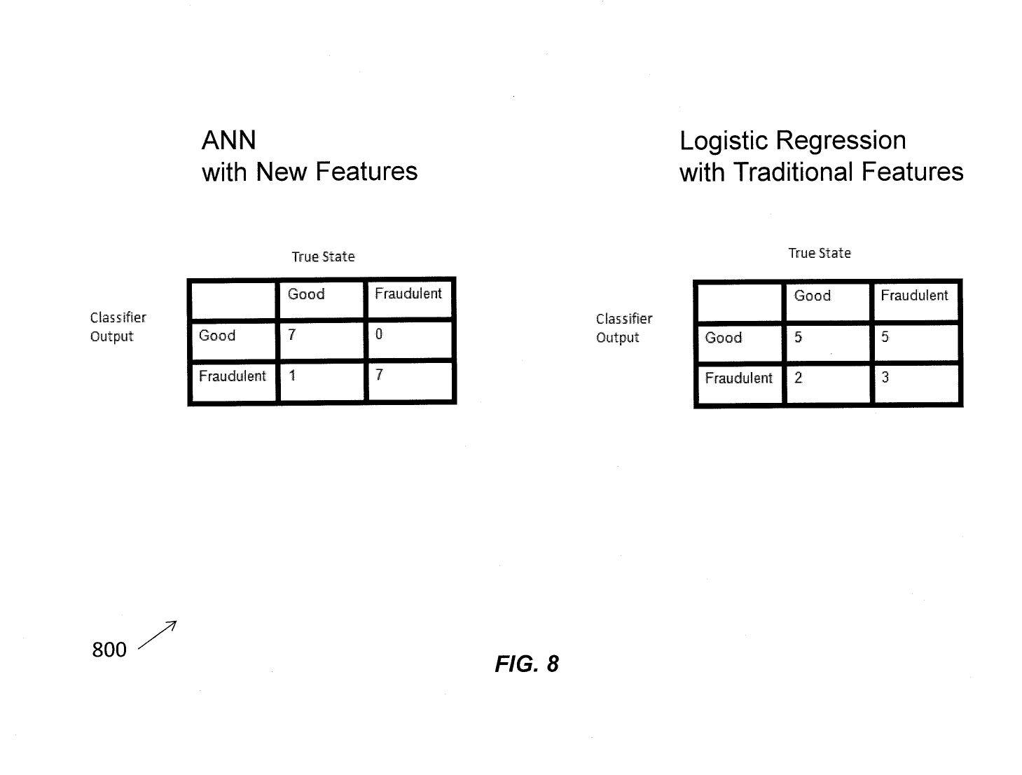

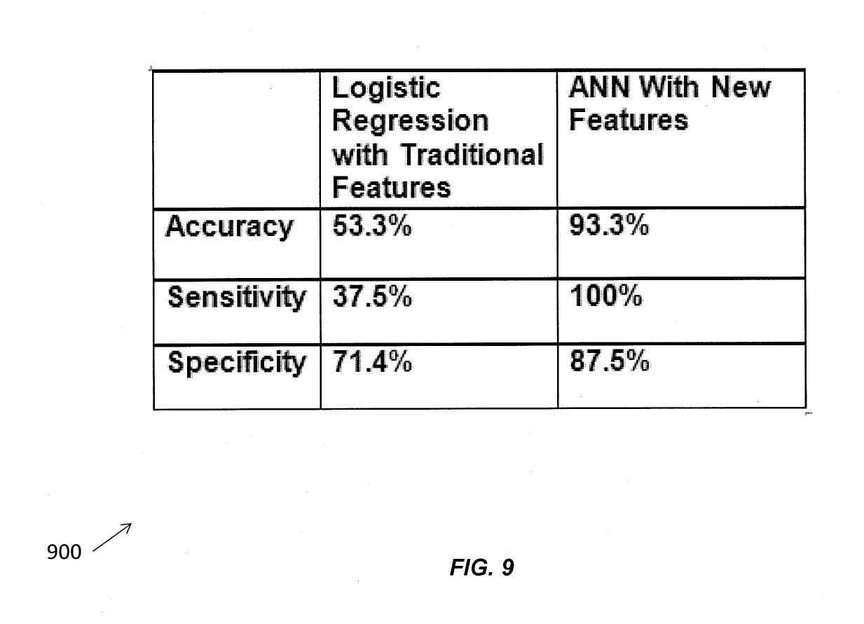

The performance of the traditional and ANN classifiers was compared along three dimensions: accuracy, sensitivity and specificity (see diagram 700 of FIG. 7). With reference to diagrams 800 and 900 of FIGS. 8 and 9, the ANN classifier exhibited markedly better performance on all three measures. Using a two proportion Z-test, the null hypothesis that the ANN exhibited no better accuracy than the traditional classifier was rejected (p<0.01).

Poor performance of the traditional approach which relies on postal/e-mail/telephone data cleansing and verification features was noted by the inventors during their research. In particular, many of the fraudulent sources exhibited pristine lead data. Fraudulent sources, aware of the data quality and consumer verification checks used by traditional techniques, have adopted effective countermeasures. By contrast, the ANN as described herein with enhanced features makes use of measures not yet compromised.

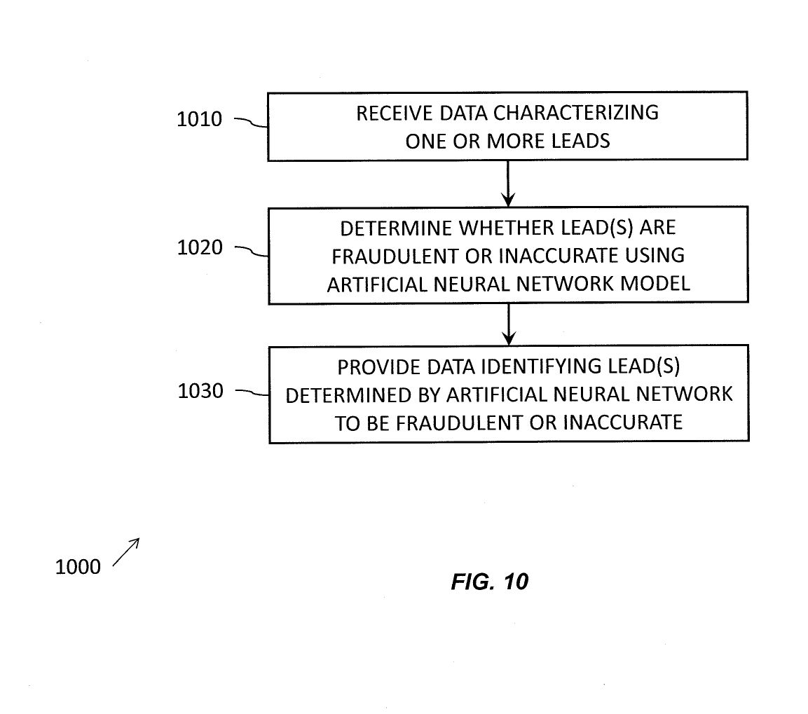

FIG. 10 is a process flow diagram illustrating a method 1000 in which, at 1010, data is received that characterizes one or more leads. Thereafter, at 1020, for each lead, it is determined whether the lead is likely to be fraudulent and/or inaccurate using at least one artificial neural network model having at least one classification feature empirically derived using a plurality of historical leads with known outcomes. Subsequently, at 1030, data is provided that identifies those leads that are determined, by the at least one artificial neural network model, to be fraudulent and/or inaccurate.

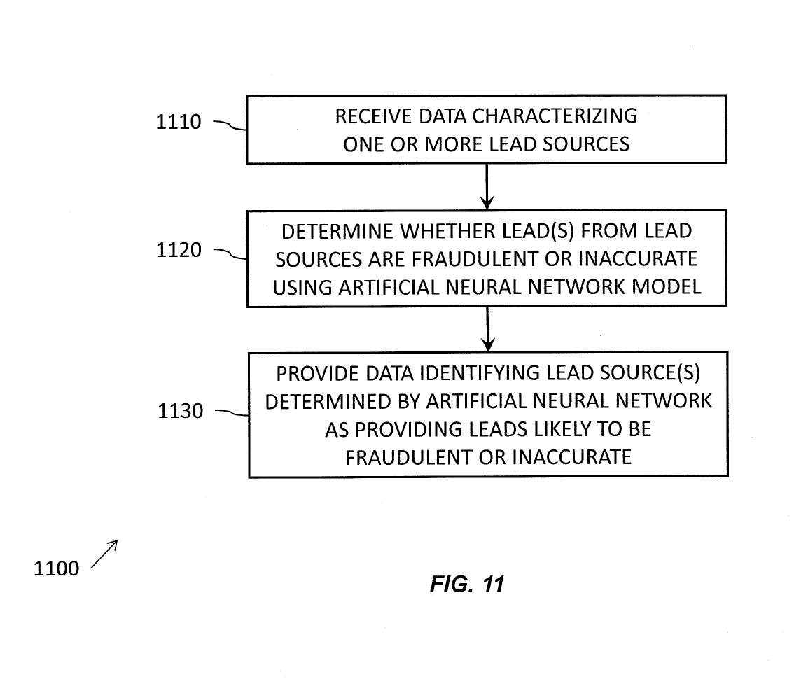

FIG. 11 is a process flow diagram illustrating a method 1100 in which, at 1110, data is received that characterizing one or more lead sources. Subsequently, at 1120, it is determined, for each of the one or more lead sources, whether the lead source provides leads likely to be fraudulent and/or inaccurate using at least one artificial neural network model having at least one classification feature empirically derived using a plurality of historical leads with known outcomes. Thereafter, at 1130, data is provided that identifies those lead sources that are determined to provide fraudulent and/or inaccurate leads.

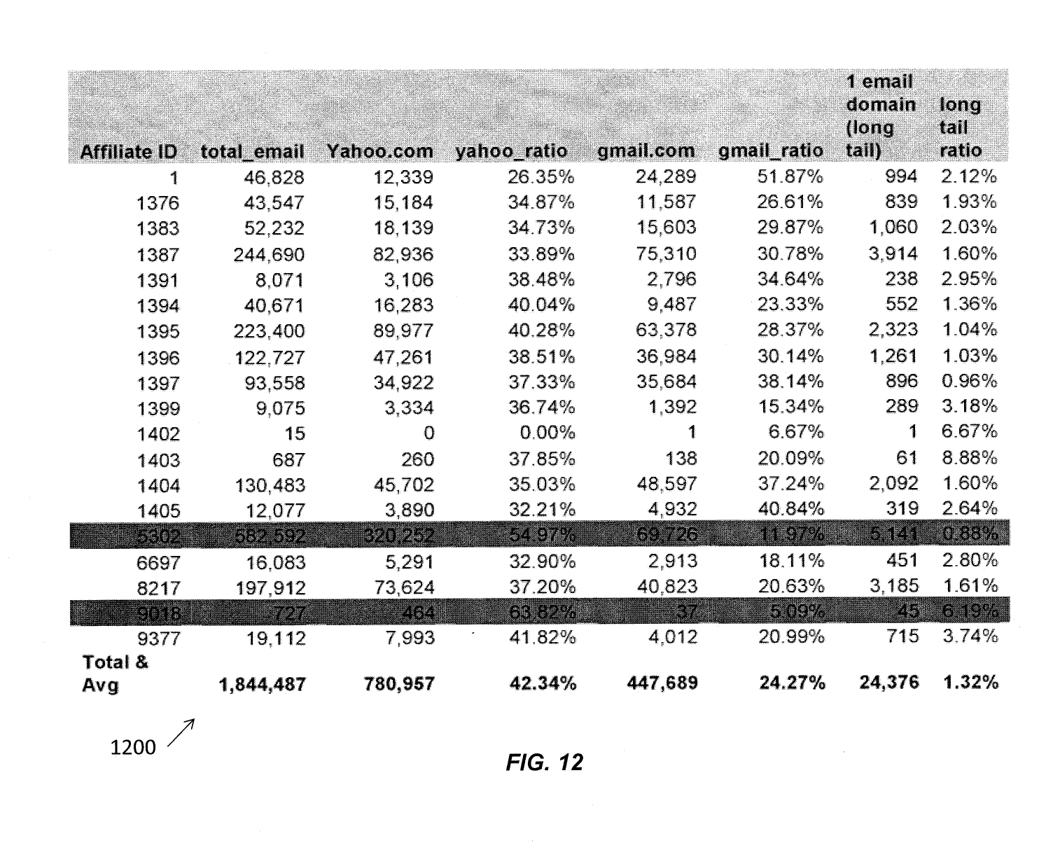

One example of data that can be used to derive one or more classification features for use with an ANN are e-mail domain distributions. As indicated on the diagram 1200 of FIG. 12, e-mail domain distribution appeared to exhibit potential in differentiating between good and fraudulent sources. For example, secondary level domain distrbutions should be related to the market shares of current e-mail providers and ISPs. For example, in FIG. 12, known fraudulent affiliates 5302 and 9018 exhibit very high proportions of YAHOO e-mail addresses and very low levels of GMAIL accounts. It is also expected that a significant number of different e-mail domains will be present in the lead stream. One simple measure of this “long tail” is the count of domain names that appear only once in a given lead stream. Although care must be taken to account for differences in the size of lead streams/sources, an overly high concentration of popular domains (such as YAHOO and GMAIL) may be indicative of programmatically forged e-mail accounts and fraud. In like manner, the distribution of top-level domains for good sources may follow a characteristic pattern.

Fraudulent e-mail opens/clicks are another type of data that can be utilized to derive one or more classification features. For example, the IP address of a consumer's device used to open or click a link within an e-mail may be captured and compared with the IP address contained in the original lead submission. Although there are certainly legitimate use cases in which these IPs may be different, in aggregate good sources should exhibit a higher degree of similarity than fraudulent sources. It can also be useful to identify IP addresses on opens/clicks associated with data centers (which in turn can be indicative of a fraudulent form bot).

Data characterizing IP duplication percentages can also be used to derive one or more classification features. Large sample sets of historical lead/fraud data may exhibit greater duplication rates than small ones. As such, measures can be implemented to normalize and classify inter and intra-source duplicates.

Data characterizing multiple IP addresses for the same consumer can also be used to derive one or more classification features. There can be legitimate cases where a single consumer might have records with different IPs (such as leads submitted from a home or work network, or while traveling). But if the practice is widespread across consumers supplied by a given lead source, or occurs at very high levels for a given consumer, it is likely indicative of fraud.

Data characterizing multiple consumers for the same IP address can also be used to derive one or more classification features. If multiple consumers share the same IP address (where statically assigned), and they are not members of the same household, it would likely be indicative of fraud. Various comparisons such as comparing the first letters of first name for those sharing an IP address can alone be helpful in identifying potential fraud.

Data characterizing a number of e-mails per consumer can also be used to derive one or more classification features. Third party e-mail append services from companies often have more than one e-mail address on file for a given consumer. While many consumers have more than one e-mail address (such as a personal and work address), there is probably no legitimate reason to have more than 5 or 10. In one example using historical data, cases existed where consumers had more than 200 e-mails associated with various leads.

Data characterizing a number of consumers per e-mail can also be used to derive one or more classification features. Although there are legitimate cases where an e-mail address might be shared (by a husband and wife in the same household, for example), the presence of a significant number of consumers (or with disparate surnames and addresses) likely indicates fraud.

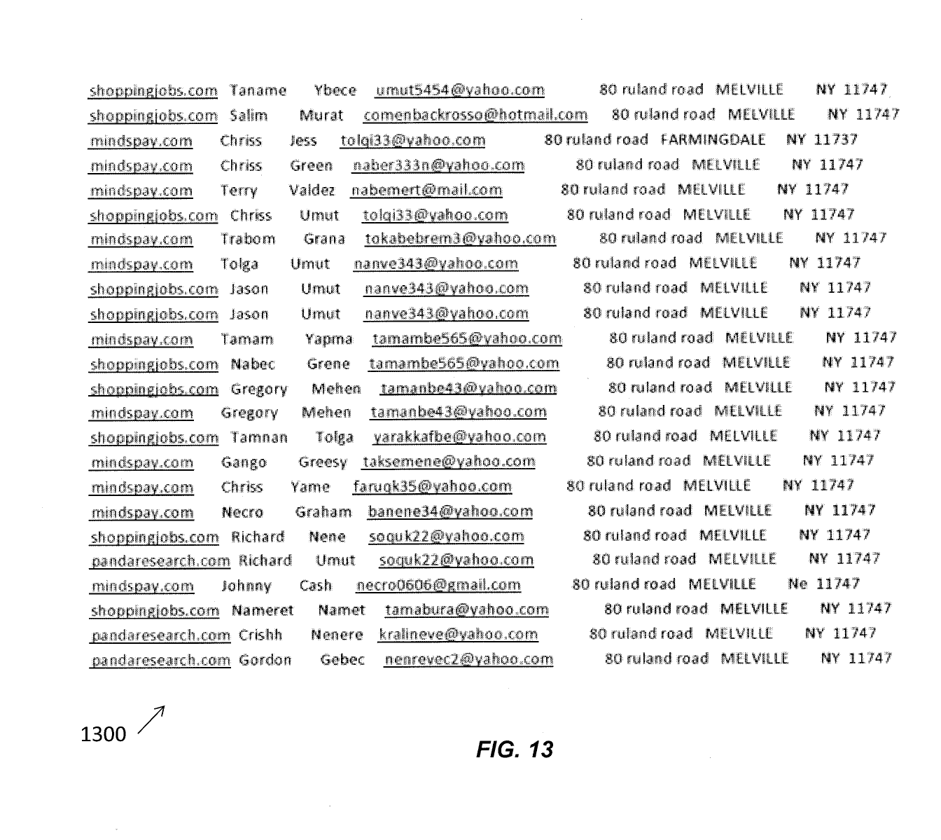

Data characterizing excessive roommate levels can also be used to derive one or more classification features. An analysis of lead data revealed excessive number of individuals purporting to live at the same address. In one particularly egregious example, 179 different individuals purported to live at 80 ruland avenue, Melville, N.Y. Examples of such data can be found in diagram 1300 of FIG. 13.

Data characterizing address line duplication can also be used to derive one or more classification features. For example, the repeated use of the same generic street address (“10 Main Street”) across different cities and states can be indicative of fraud. In many cases this may pass DPV but still be fraudulent.

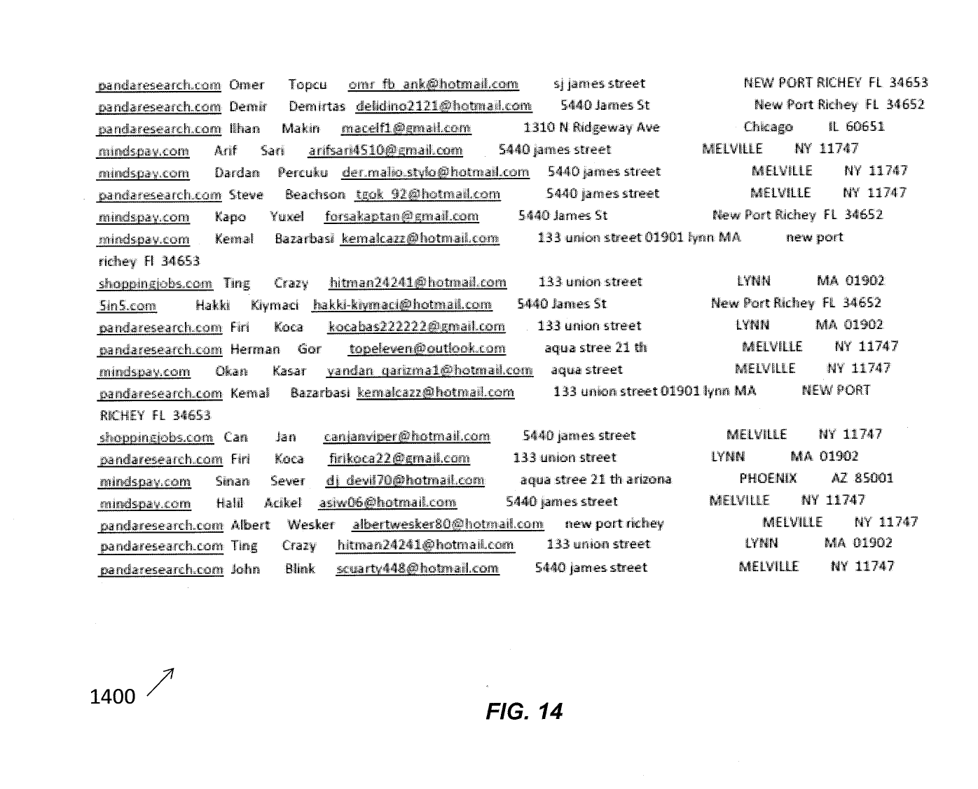

Data characterizing telephone number sharing can also be used to derive one or more classification features. The presence of different households or addresses associated with a telephone number can indicate fraud. For example, in a recent analysis 66 records, as shown in the diagram 1400 of FIG. 14, shared the same phone number (8002524634).

Geographic distribution data can also be used to derive one or more classification features. For a nationally-sourced lead campaign, excessive geographic concentration may be indicative of fraud. The expected lead distribution (by state, or even MSA/city/zip) can be compared to the actual distribution. Significant deviations (as measured with a Chi Square test) might suggest a likelihood of fraud.

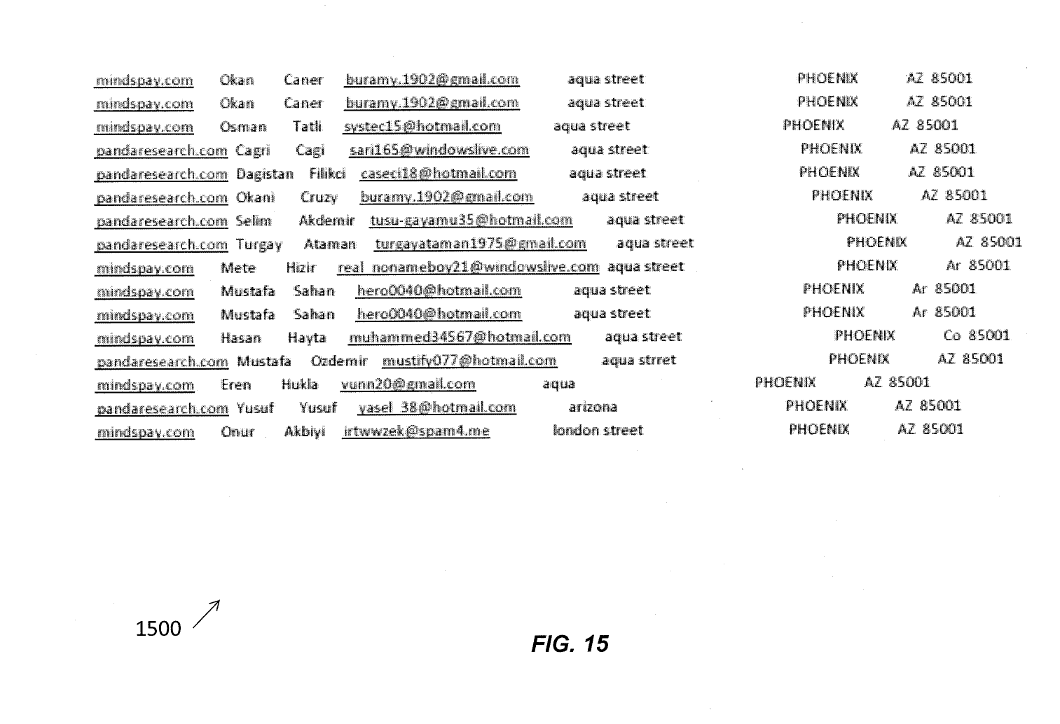

Data characterizing given and surname analytics can also be used to derive one or more classification features. Although the US is a diverse country, the distribution of given and surnames should roughly follow the distribution in the country. One interesting example found in the data showed a high concentration of Turkish names as shown in diagram 1500 of FIG. 15 in an area of Phoenix that does not have a significant number of residents that are associated with Turkey in some manner. These leads would also be flagged by the ANN as fraudulent for other reasons (such as the widespread duplication of address fields).

The current subject matter can be used with connection with the methods, techniques, and articles described and illustrated in U.S. patent application Ser. No. 13/588,900 entitled “Online Lead Fraud Detection”, filed on Aug. 17, 2012, the contents of which are hereby fully incorporated by reference.

One or more aspects or features of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device (e.g., mouse, touch screen, etc.), and at least one output device.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter.

Although a few variations have been described in detail above, other modifications or additions are possible. For example, while the current subject matter is largely directed to identifying fraud, the current techniques are also applicable to identifying inaccuracies and/or errors on behalf of a user. In particular, a user may make a typographic error or the like which, while not fraudulent, makes such lead unusable. In particular, further features and/or variations can be provided in addition to those set forth herein. Further, the implementations described above can be directed to various combinations and subcombinations of the disclosed features and/or combinations and subcombinations of several further features disclosed above. In addition, the logic flow(s) depicted in the accompanying figures and/or described herein do not necessarily require the particular order shown, or sequential order, to achieve desirable results. Other implementations may be within the scope of the following claims.

What is claimed is:

1. A computer-implemented method comprising:
receiving data characterizing one or more leads;
determining, for each of the one or more leads, whether the lead is likely to be fraudulent and/or inaccurate using at least one artificial neural network model having at least one classification feature empirically derived using a plurality of historical leads with known outcomes; and
providing data identifying those leads that are determined to be fraudulent and/or inaccurate.

2. A method as in claim 1, wherein providing data comprises at least one of storing data, loading data, displaying data, and transmitting data.

3. A method as in claim 1, wherein the artificial neural network model is used to generate a score for each lead, wherein scores above a pre-determined threshold are determined to be likely fraudulent or inaccurate.

4. A method as in claim 1, wherein the leads comprise web-generated leads.

5. A method as in claim 4, wherein the web-generated leads comprise user-generated subscriptions or account registrations on a website.

6. A method as in claim 5, wherein the web-generated leads comprise user-generated requests for products and/or services.

7. A method as in claim 1, wherein the at least one empirically derived classification feature is based on a time of day calculation threshold.

8. A method as in claim 1, wherein the at least one empirically derived classification feature is based a number of prior moves as percentage of total lead volume.

9. A method as in claim 1, wherein the at least one empirically derived classification feature is based on IP hostname binding percentages.

10. A method as in claim 1, wherein the at least one empirically derived classification feature is based on IP address geolocation percentages.

11. A method as in claim 1, wherein the at least one empirically derived classification feature is based on e-mail domain distribution for leads coming from each lead source.

12. A method as in claim 1, wherein the at least one empirically derived classification feature is based on a comparison of a captured IP address with an IP address associated with a lead submission.

13. A method as in claim 1, wherein the at least one empirically derived classification feature is based on a percentage of duplicate IP addresses within a plurality of leads.

14. A method as in claim 1, wherein the at least one empirically derived classification feature is based on a number of IP addresses associated with a single consumer.

15. A method as in claim 1, wherein the at least one empirically derived classification feature is based on a number of consumers associated with a single IP address.

16. A method as in claim 1, wherein the at least one empirically derived classification feature is based on a number of e-mail addresses associated with a single consumer.

17. A method as in claim 1, wherein the at least one empirically derived classification feature is based on a number of consumers associated with a single e-mail address.

18. A method as in claim 1, wherein the at least one empirically derived classification feature is based on a number of individuals having different last names associated with a single physical place of residence.

19. A method as in claim 1, wherein the at least one empirically derived classification feature is based on a frequency of use for a particular street address.

20. A method as in claim 1, wherein the at least one empirically derived classification feature is based on a number of consumers associated with a single telephone number.

21. A method as in claim 1, wherein the at least one empirically derived classification feature is based on a geographic distribution of a plurality of leads.

22. A method as in claim 1, wherein the at least one empirically derived classification feature is based on a percentage of names having a common ethnic origin as compared to population statistics characterizing ethnic origins of individuals within a geographic territory.

23. A computer-implemented method comprising:
receiving data characterizing one or more lead sources;
determining, for each of the one or more lead sources, whether the lead source provides leads likely to be fraudulent and/or inaccurate using at least one artificial neural network model having at least one classification feature empirically derived using a plurality of historical leads with known outcomes; and
providing data identifying those lead sources that are determined to provide fraudulent and/or inaccurate leads.

24. A non-transitory computer program product storing instructions, which when executed by at least one data processor of at least one computing system, result in operations comprising:
receiving data characterizing one or more leads;
determining, for each of the one or more leads, whether the lead is likely to be fraudulent and/or inaccurate using at least one artificial neural network model having at least one classification feature empirically derived using a plurality of historical leads with known outcomes; and
providing data identifying those leads that are determined to be fraudulent and/or inaccurate.
